(19) United States
(12) Patent Application Publication
(10) Pub. No.: US 2011/0128401 A1
(43) Pub. Date: Jun. 2, 2011

(54) DIGITAL PHOTOGRAPHING APPARATUS AND METHOD OF CONTROLLING THE SAME

(75) Inventors: Myung-kyu Choi, Suwon-si (KR); Dae-hong Ki, Suwon-si (KR)

(73) Assignee: Samsung Electronics Co., Ltd., Suwon-si (KR)

(21) Appl. No.: 12/949,107

(22) Filed: Nov. 18, 2010

(30) Foreign Application Priority Data
Nov. 30, 2009 (KR) 10-2009-0116839

(51) Int. Cl. H04N 5/228

(52) U.S. Cl. 348/222.1; 348/E05.031

(57) ABSTRACT

A digital photographing apparatus and a method of controlling the same. The digital photographing apparatus includes: a first display unit disposed on a rear surface of the digital photographing apparatus; a second display unit disposed on a front surface of the digital photographing apparatus; and a digital signal processing unit for turning on the second display unit if a face is detected in an input image.

### CROSS-REFERENCE TO RELATED PATENT APPLICATION

This application claims the benefit of Korean Patent Application No. 10-2009-0116839, filed on Nov. 30, 2009, in the Korean Intellectual Property Office, the disclosure of which is incorporated herein in its entirety by reference.

### BACKGROUND

The invention relates to a digital photographing apparatus, and more particularly, to a digital photographing apparatus including a plurality of display units, and a method of controlling the digital photographing apparatus.

Dual-display digital photographing apparatuses, such as a digital camera and a digital camcorder, can display the same image on two display units. For example, dual-display digital photographing apparatuses can display the same live view image, preview image, play view image, or the like, on two display units.

A front liquid crystal display (LCD) unit as an auxiliary to a main LCD unit of a dual-display digital photographing apparatus is turned on or off according to a user's manipulation.

### SUMMARY

Various embodiments of the invention provide a digital photographing apparatus including a front display unit that is turned on or off according to a result of face detection, and a method of controlling the digital photographing apparatus.

Various embodiments of the invention also provide a digital photographing apparatus that automatically captures an input image if a detected face is a registered face, and a method of controlling the digital photographing apparatus.

According to an embodiment of the invention, there is provided a digital photographing apparatus including: a first display unit disposed on a rear surface of the digital photographing apparatus; a second display unit disposed on a front surface of the digital photographing apparatus; and a digital signal processing unit for turning on the second display unit if a face is detected in an input image.

The digital signal processing unit may include: a face detecting unit for detecting a face in the input image; and a control unit for turning on the second display unit if a face is detected in the input image.

If a face is detected in the input image, the control unit may turn on the second display unit after a predetermined period of time elapses.

If no face is detected in the input image, the control unit may turn off the second display unit after a predetermined period of time elapses.

The control unit may control the face detecting unit to perform face detection on the input image after the predetermined period of time elapses.

According to another embodiment of the invention, there is provided a digital photographing apparatus including: a first display unit disposed on a rear surface of the digital photographing apparatus; a second display unit disposed on a front surface of the digital photographing apparatus; and a digital signal processing unit for, if a face is detected in an input image, performing face recognition by comparing the detected face with a registered face, and continuously photographing the input image according to a result of the face recognition.

The digital signal processing unit may include: a face detecting unit for detecting a face in the input image; a face recognizing unit for performing face recognition by comparing the detected face with the registered face; a continuous photographing control unit for controlling the input image to be continuously captured; and a control unit for, if the detected face is the registered face, controlling the continuous photographing control unit to continuously capture the input image.

The digital signal processing unit may further include a photographing mode determining unit for determining whether a current photographing mode of the digital photographing apparatus is a self-photographing mode, wherein, if the detected face is the registered face and the current photographing mode is a self-photographing mode, the control unit controls the continuous photographing control unit to continuously capture the input image.

According to another embodiment of the invention, there is provided a method of controlling a digital photographing apparatus including a first display unit and a second display unit, the method including: detecting a face in an input image; and turning on the second display unit if a face is detected in the input image.

The turning-on of the second display unit may include turning on the second display unit after a predetermined period of time elapses.

If no face is detected in the input image, the method may further include turning off the second display unit after a predetermined period of time elapses.

The method may further include performing face detection in the input image after the predetermined period of time elapses.

According to another embodiment of the invention, there is provided a method of controlling a digital photographing apparatus including a first display unit and a second display unit, the method including: detecting a face in an input image; performing face recognition by comparing the detected face with a registered face; and continuously capturing the input image according to a result of the face recognition.

The continuously capturing of the input image may include continuously capturing the input image if the detected face is the registered face.

The method may further include determining whether a current photographing mode of the digital photographing apparatus is a self-photographing mode, wherein the continuously capturing of the input image includes continuously capturing the input image if the detected face is the registered face and the current photographing mode is a self-photographing mode.

The first display unit may be disposed on a rear surface of the photographing apparatus, and the second display unit may be disposed on a front surface of the digital photographing apparatus.

According to another embodiment of the invention, there is provided a non-transient computer-readable recording medium having embodied thereon a program for executing the method on a processor.

### BRIEF DESCRIPTION OF THE DRAWINGS

The above and other features and advantages of the invention will become more apparent by describing in detail exemplary embodiments thereof with reference to the attached drawings in which:

FIGS. 1A and 1B are front and back views that respectively illustrate a front surface and a rear surface of a digital photographing apparatus according to an embodiment of the invention;

FIG. 2 is a block diagram of the digital photographing apparatus of FIG. 1; and

FIG. 3 is a block diagram of a digital signal processing unit illustrated in FIG. 2;

FIG. 4 is a flowchart illustrating a method of controlling the digital photographing apparatus of FIG. 1, according to an embodiment of the invention;

FIG. 5 is a flowchart illustrating a method of controlling the digital photographing apparatus of FIG. 1, according to another embodiment of the invention;

FIG. 6 is a flowchart illustrating a method of controlling the digital photographing apparatus of FIG. 1, according to another embodiment of the invention;

FIG. 7 is a flowchart illustrating a method of controlling the digital photographing apparatus of FIG. 1, according to another embodiment of the invention;

FIGS. 8A-8D are pictorial views for explaining a method of controlling the digital photographing apparatus of FIG. 1, according to another embodiment of the invention;

### DETAILED DESCRIPTION

Various embodiments of the invention will now be described more fully with reference to the accompanying drawings, in which exemplary embodiments of the invention are shown. Only techniques and structures necessary for understanding the invention will be described and other techniques or structures which may unnecessarily make the invention unclear will not be described.

The terms and words which are used in the present specification and the appended claims should not be construed as being confined to common meanings or dictionary meanings but should be construed as meanings and concepts matching the technical spirit of the invention in order to describe the invention in the best fashion.

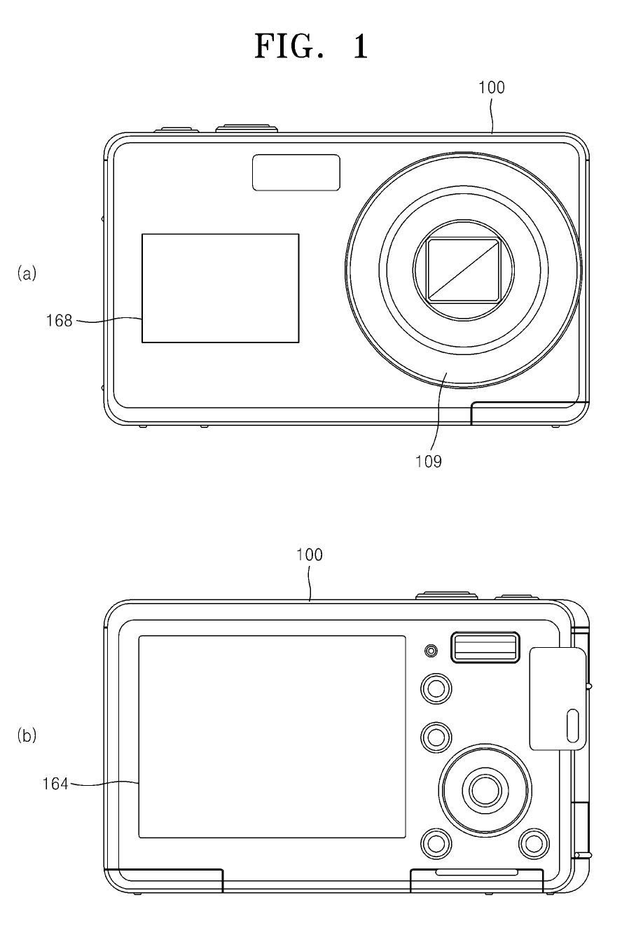

FIG. 1 illustrates an outer appearance of a digital photographing apparatus 100 according to an embodiment of the invention. The digital photographing apparatus 100 may include a first display unit 164 disposed on a rear surface thereof, and a second display unit 168 disposed on a front surface thereof. Referring to FIG. 1A, the first display unit 164 may be disposed on a surface opposite to a surface on which a lens barrel 109 is disposed, and the second display unit 168 may be disposed on the surface on which the lens barrel 109 is disposed.

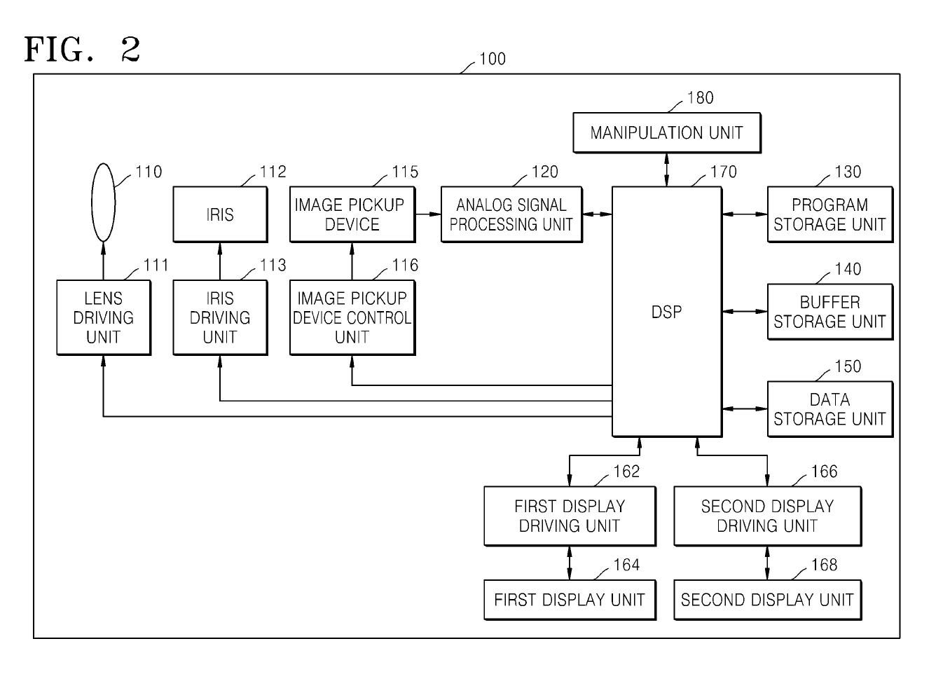

FIG. 2 is a block diagram of the digital photographing apparatus 100 of FIG. 1.

Referring to FIG. 2, the digital photographing apparatus 100 may include a lens 110, a lens driving unit 111, an iris 112, an iris driving unit 113, an image pickup device 115, an image pickup device control unit 116, an analog signal processing unit 120, a program storage unit 130, a buffer storage unit 140, a data storage unit 150, a first display driving unit 162, the first display unit 164, a second display driving unit 166, the second display unit 168, a digital signal processing unit 170, and a manipulation unit 180.

The lens 110 obtains an optical signal. The lens 110 may include a zoom lens for widening or narrowing a viewing angle according to a focal length of the lens 110, and a focus lens for focusing on a subject. Each of the zoom lens and the focus lens may be formed as a single lens or a group of a plurality of lenses.

The iris 112 adjusts the amount of light incident on the image pickup device according to an opening degree of the iris.

The lens driving unit 111 and the iris driving unit 113 receive control signals from the digital signal processing unit 170, and respectively drive the lens 110 and the iris 112. The lens driving unit 111 adjusts the focal length of the lens 110 by adjusting the position of the lens 110, and performs auto focusing, zoom changing, focus changing, and the like. The iris driving unit 113 adjusts the opening degree of the iris 112, and performs auto focusing, automatic exposure adjustment, focus changing, field depth adjustment, and the like by adjusting an F number.

The optical signal passing through the lens 110 reaches a light-receiving surface of the image pickup device 115 and forms an image of the subject. The image pickup device 115 may be a complementary metal oxide semiconductor image sensor (CIS) or a charge coupled device (CCD) to convert the optical signal into an electric signal. Sensitivity of the image pickup device 115 may be controlled by the image pickup device control unit 116. The image pickup device control unit 116 may control the image pickup device 115 according to a control signal that is manually input by a user's manipulation, or a control signal that is automatically generated in response to an image signal that is input in real time.

An exposure time of the image pickup device 115 is adjusted by using a shutter (not shown). The shutter may be a mechanical shutter for adjusting the amount of light incident on the image pickup device 15 by moving a lens shade up and down, or an electronic shutter for adjusting the amount of incident light by applying an electric signal to the image pickup device 115.

The analog signal processing unit 120 performs noise reduction, gain control, waveform shaping, analog-digital conversion, and the like, on an analog signal applied from the image pickup device 115.

The digital photographing apparatus 100 includes the program storage unit 130 for storing programs of, for example, operating and application systems, the buffer storage unit 140 for temporarily storing data necessary for and result data of various operations, and the data storage unit 150 for storing various types of data necessary for the programs, for example, image files including image signals.

The digital photographing apparatus 100 includes the first display unit 164 and the second display unit 168 for displaying an operation state of the digital photographing apparatus 100 or image data captured by the digital photographing apparatus 100. The first display unit 164 and the second display unit 168 may provide visual information and/or audible information to the user. In order to provide visual information to the user, the first display unit 164 and the second display unit 168 may include a liquid crystal display (LCD) panel or an organic light-emitting display (OLED) panel. The first display driving unit 162 and the second display driving unit 166 respectively provide driving signals to the first display unit 164 and the second display unit 168. Although the first display driving unit 162 and the second display driving unit 166 separately drive the first display unit 164 and the second display unit 168 in FIG. 2, the present embodiment is not limited thereto and one display driving unit may drive both the first display unit 164 and the second display unit 168.

The digital photographing apparatus 100 includes the digital signal processing unit 170 for processing an input image signal and controlling each element of the digital photographing apparatus 100 according to the input image signal or an external input signal. The digital signal processing unit 170 may reduce noise in input image data, and perform image signal processing for image quality improvement, such as gamma correction, color filter array interpolation, color matrix, color correction, or color enhancement. The digital signal processing unit 170 may generate an image file by compressing image data that is generated by the image signal processing for image quality improvement, and restore the image data from the image file. The image data may be reversibly or irreversibly compressed in a joint photographic experts group (JPEG) format or a JPEG2000 format. The image file may be stored in the data storage unit 150. The digital signal processing unit 170 may perform sharpening, color processing, blur processing, edge emphasis, image analysis, image recognition, image effect processing, or the like. The image recognition may include face recognition and scene recognition. Also, the digital signal processing unit 170 may perform image signal processing to display an image on the first display unit 164 and the second display unit 168. For example, the digital signal processing unit 170 may perform image synthesis such as brightness adjustment, color correction, contrast adjustment, outline emphasis, screen split, or character image generation. The digital signal processing unit 170 may perform image signal processing to display image data on an external monitor by being connected to the external monitor.

Also, the digital signal processing unit 170 may execute the programs stored in the program storage unit 130, generate a control signal for controlling auto focusing, zoom change, focus change, automatic exposure correction, and the like by using a separate module, provide the control signal to the lens driving unit 111, the iris driving unit 113, and the image pickup device control unit 116, and control operations of the elements included in the digital photographing apparatus 100, such as the shutter and a flash.

The manipulation unit 180 may include a member for the user to manipulate the digital photographing apparatus 100 or to manage various photographing settings. For example, the manipulation unit 180 may include buttons, keys, a touch panel, a touch screen, a dial, or the like. The manipulation unit 180 may input user manipulation signals such as power on/off signals, photographing start/stop signals, reproduction start/stop/search signals, a lens driving signal, a mode change signal, a menu manipulation signal, a selection manipulation signal, and the like. For example, a shutter button may be half-pressed, full-pressed, or released by the user. A focus control start manipulation signal is output when the shutter button is half-pressed (manipulation S1), and focus control is terminated when the half-pressed shutter button is released. A photographing start manipulation signal may be output when the shutter button is full-pressed (manipulation S2). A manipulation signal may be transmitted to the digital signal processing unit 170 to drive an element corresponding to the manipulation signal.

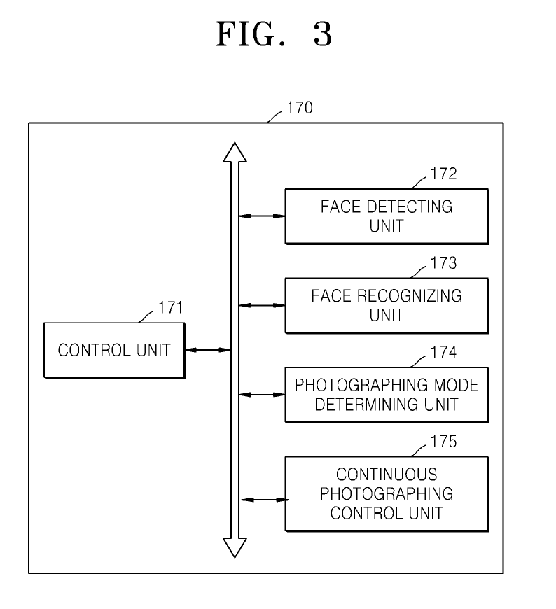

FIG. 3 is a block diagram of the digital signal processing unit 170 illustrated in FIG. 2.

The digital signal processing unit 170 turns on the second display unit 168 if a face is detected in an input image. Here, the first display unit 164, which performs a main display function in a general photographing mode or a reproduction mode, is turned on or off according to a power-on or power-off state of the digital photographing apparatus 100, whereas the second display unit 168, which performs an auxiliary display function, is turned on when a face is detected in the input image.

Referring to FIG. 3, the digital signal processing unit 170 includes a control unit 171, a face detecting unit 172, a face recognizing unit 173, a photographing mode determining unit 174, and a continuous photographing control unit 175.

The control unit 171 controls the overall operation of the digital signal processing unit 170.

The face detecting unit 172 detects, if present, a face in an input image.

Here, an input image refers to a live view image input in a photographing mode. Face detection refers to a process of determining whether a face is present in an input image or the location of a face in an input image. For example, the face detecting unit determines whether facial feature data exists in an input image by comparing input image data with stored facial feature data, and determines the location of the facial feature data if it is determined that the facial feature data is present in the input image. There are many conventional techniques for face detection. For example, a face region may be detected by using an Adaboosting algorithm or skin color information.

If a face is detected in the input image by the face detecting unit 172, the control unit 171 outputs a control signal for turning on the second display unit 168 to the second display driving unit 166 to turn on the second display unit 168. The control unit 171 may turn on the second display unit 168 after a predetermined period of time elapses. Also, if no face is detected in the input image, the control unit 171 may turn off the second display unit 168 after a predetermined period of time elapses. Since the second display unit 168 is turned on or off according to whether a face is detected after a predetermined period of time elapses, not right after it is determined that a face is detected or not detected, the user or a person who is viewing the second display unit 168 may feel comfortable with having the second display unit 168 switch between turning on and off. Alternatively, if no face is detected in the input image, the control unit 171 may control the face detecting unit 172 to perform face detection in the input image again, instead of turning off the second display unit 168 after a predetermined period of time elapses. Here, a predetermined response time may be arbitrarily set by the user or may be set to a default value.

The face detecting unit 173 performs face recognition by comparing the face detected by the face detecting unit 172 with registered faces. In general, face recognition includes five steps, that is, face detection, eye detection, face normalization, facial feature point extraction, and face recognition. The face detection and the eye detection distinguish a face image from a non-face image and an eye image from a non-eye image, and use an Adaboost algorithm and a modified census transform algorithm in order to detect a face and eyes. The face normalization corrects the size, inclination, and rotation of the face based on the face and the eyes detected by the face detection and the eye detection. The face normalization extracts feature points of the face by using, for example, a two dimensional principal component analysis (2D-PCA) algorithm. Whether the detected face is the same as one of the registered faces is determined according to whether feature points of the detected face are matched to feature points of the registered face.

The photographing mode determining unit 174 determines whether a current photographing mode is a self-photographing mode. For example, if the face amounts to more than a certain percentage of a total area of the input image, by considering an average arm length, that is, a distance between the digital photographing apparatus 100 and the subject, and optical characteristics of the digital photographing apparatus 100, it may be determined that the current photographing mode is a self-photographing mode. Here, a self-photographing mode may be set by the user in advance.

If it is determined that the user's face is detected as a result of the face recognition performed by the face recognizing unit 173, the control unit 171 controls the continuous photographing control unit 175 to perform continuous photographing. Alternatively, if it is determined that the user's face is detected and recognized and the photographing mode determining unit 174 determines that the current photographing mode is a self-photographing mode, the control unit 171 controls the continuous photographing control unit 175 to automatically perform continuous photographing.

The continuous photographing control unit 175 performs continuous photographing under the control of the control unit 171. Here, continuous photographing, also called bracketing, refers to a technique of capturing two or more images in succession. Accordingly, if the current photographing mode is a self-photographing mode in which the user photographs his/her face, a plurality of images may be obtained, and a best image among the plurality of images may be selected and stored.

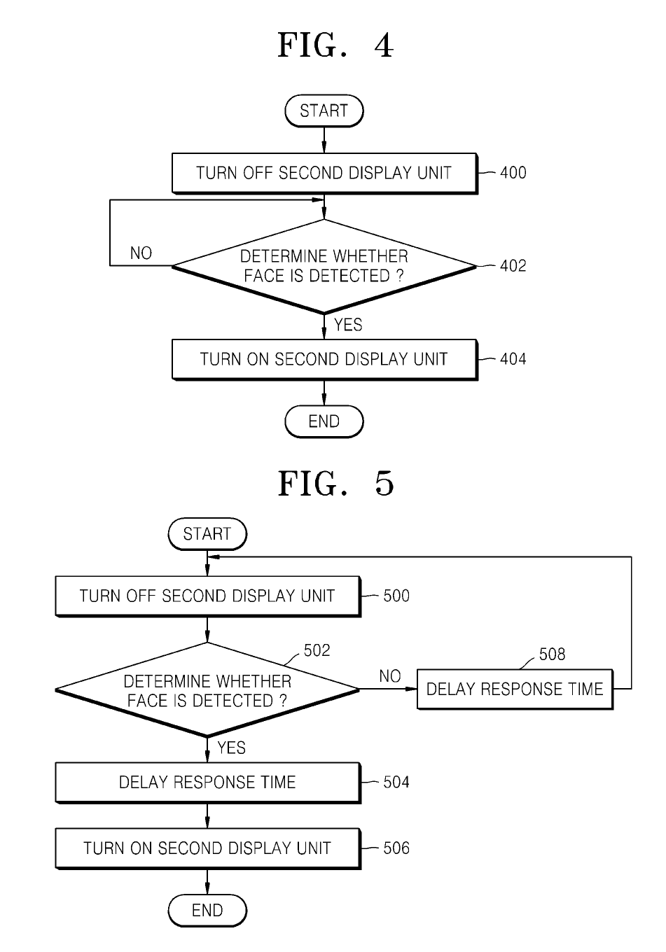

FIG. 4 is a flowchart illustrating a method of controlling the digital photographing apparatus 100 of FIG. 1, according to an embodiment of the invention.

Referring to FIG. 4, in operation 400, the second display unit 168 is turned off. Here, the second display unit 168 is disposed on the front surface of the digital photographing apparatus 100 and performs an auxiliary display function. In operation 402, it is determined whether a face is detected in an input image. If it is determined in operation 402 that a face is detected in the input image, the method proceeds to operation 404. In operation 404, the second display unit 168 is turned on.

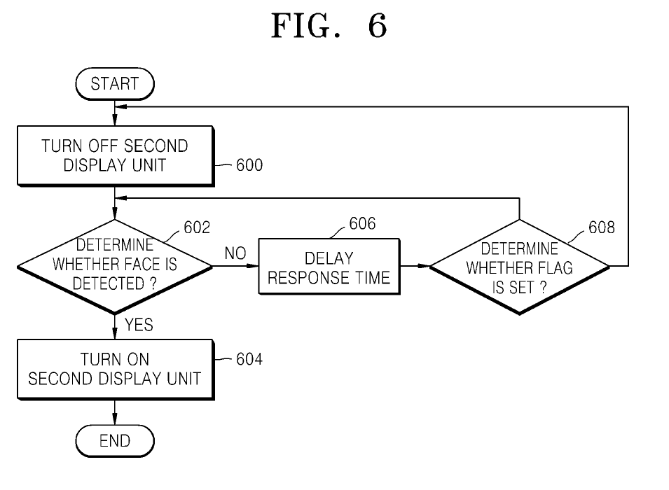

FIG. 5 is a flowchart illustrating a method of controlling the digital photographing apparatus of FIG. 1, according to another embodiment of the invention.

Referring to FIG. 5, in operation 500, the second display unit 168 is turned off. In operation 502, it is determined whether a face is detected in an input image. If it is determined in operation 502 that a face is detected in the input image, the method proceeds to operation 504. In operation 504, a response time is delayed. Here, the response time refers to a response time taken to turn on the second display unit 168. In operation 506, the second display unit 168 is turned on. If it is determined in operation 502, however, that no face is detected in the input image, the method proceeds to operation 508. In operation 508, a response time is delayed. Here, the response time refers to a response time taken to turn off the second display unit 168. Accordingly, even when no face is detected, since the second display unit 168 is slowly turned off after a predetermined period of time elapses, the user or a person who is viewing the second display unit 168 may feel comfortable having the second display unit 168 switch between turning on and off.

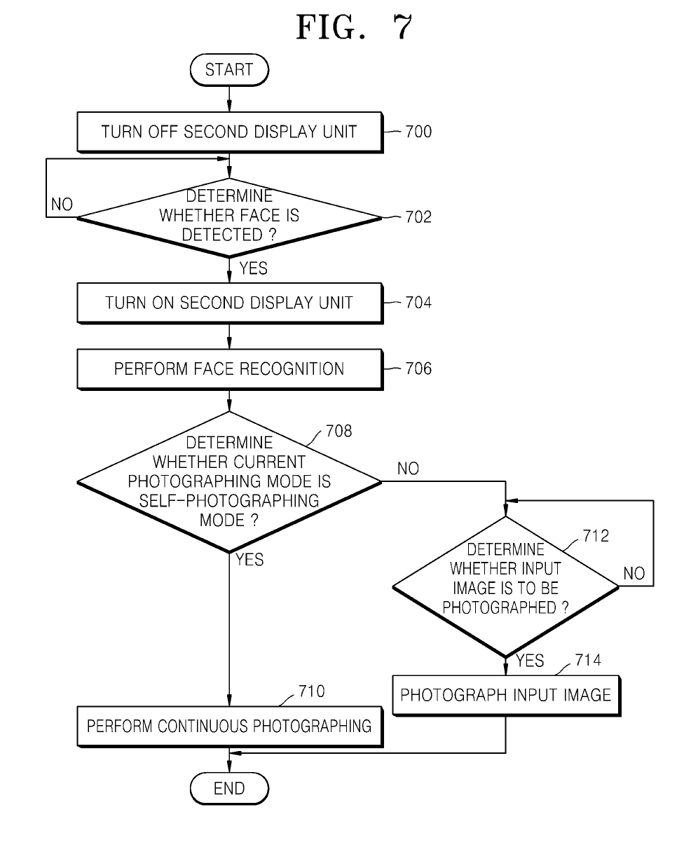

FIG. 6 is a flowchart illustrating a method of controlling the digital photographing apparatus 100 of FIG. 1, according to another embodiment of the invention.

Referring to FIG. 6, in operation 600, the second display unit 168 is turned off. In operation 602, it is determined whether a face is detected in an input image. If it is determined in operation 602 that a face is detected in the input image, the method proceeds to operation 604. In operation 604, the second display unit 168 is turned on. If it is determined in operation 602, however, that no face is detected in the input image, the method proceeds to operation 606. In operation 606, a response time is delayed. In operation 608, it is determined whether a flag for turning on or off the second display unit 168 is set. If it is determined in operation 608 that the flag is set, the method proceeds to operation 602. In operation 602, it is determined again whether a face is detected in the input image. If it is determined in operation 608, however, that the flag is not set, the method proceeds to operation 600. In operation 600, the second display unit 168 is turned off.

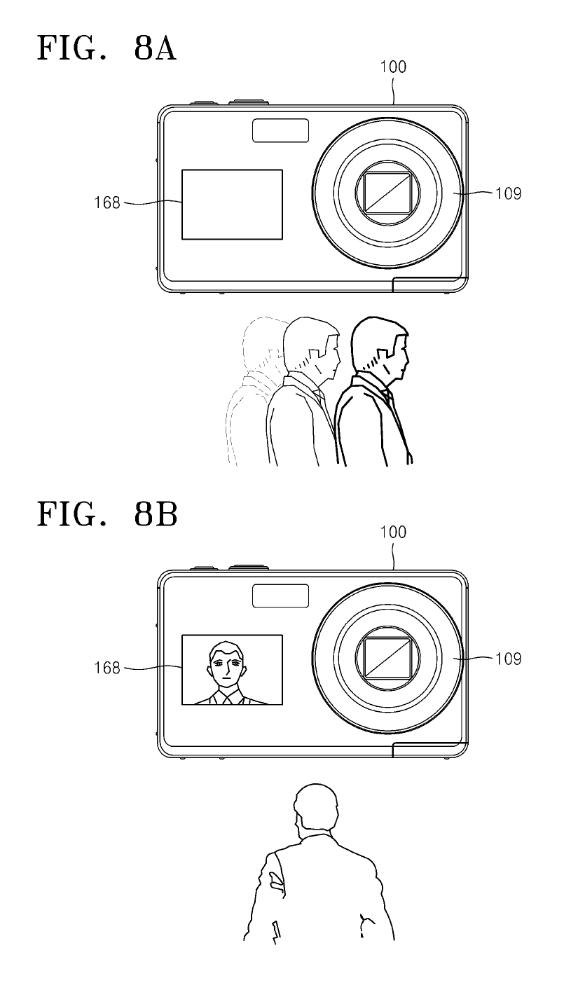

FIG. 7 is a flowchart illustrating a method of controlling the digital photographing apparatus 100 of FIG. 1, according to another embodiment of the invention.

Referring to FIG. 7, in operation 700, the second display unit 168 is turned off. In operation 702, it is determined whether a face is detected in an input image. If it is determined in operation 702 that a face is detected in the input image, the method proceeds to operation 704. In operation 704, the second display unit 168 is turned on. In operation 706, face recognition is performed to determine whether the face detected in operation 702 is the same as one of stored or registered faces. In operation 708, it is determined whether a current photographing mode is a self-photographing mode. If it is determined in operation 708 that the current photographing mode is a self-photographing mode, the method proceeds to operation 710. In operation 710, continuous photographing is performed. The operation 708 where it is determined whether the current photographing mode is a self-photographing mode may be omitted. That is, if it is determined in operation 706 that the detected image is the same as one of the stored or registered faces as a result of the face recognition, the method directly proceeds to operation 710. In operation 710, continuous photographing is automatically performed. If it is determined in operation 708, however, that the current photographing mode is not a self-photographing mode, the method proceeds to operation 712. In operation 712, the user presses a photographing button. In operation 714, the input image is captured. Accordingly, since the second display unit 168, which is a front display unit, is automatically turned on according to a result of face detection, and continuous photographing is performed if it is determined that a current photographing mode is a self-photographing mode in which the user photographs his/her face according to face recognition information that is previously registered, successful self-photographing is more likely to occur. That is, the second display unit 168 is automatically turned on when the user is viewing the digital photographing apparatus 100, so that when the user is well composed by using an image displayed on the second display unit 168, continuous photographing may be automatically performed.

Although a method of controlling the second display unit 168 to be turned on by detecting a face and a method of automatically performing continuous photographing after face detection and face recognition have been collectively described with reference to FIG. 7, the two methods may be individually implemented.

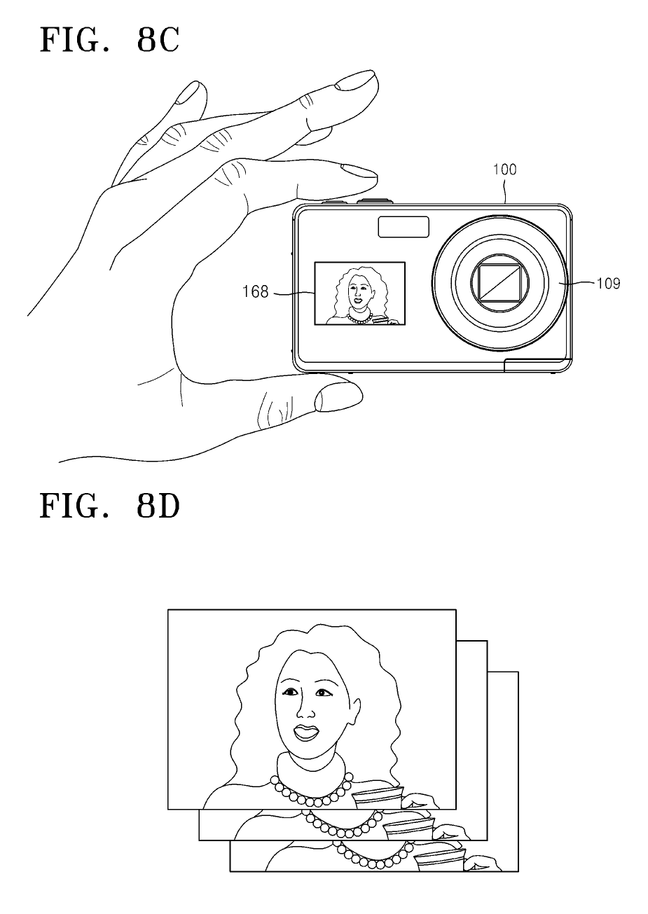

FIGS. 8A through 8D illustrate schematic views for explaining a method of controlling the digital photographing apparatus 100 of FIG. 1, according to another embodiment of the invention.

Referring to FIG. 8, if no face is detected by the digital photographing apparatus 100, that is, if the user does not stare directly at the digital photographing apparatus 100, the second display unit 168 is not turned on. However, referring to FIG. 8B, if the user stares directly at the digital photographing apparatus 100, the second display unit 168 is turned on and an input image is displayed on the second display unit 168.

Referring to FIG. 8C, it is determined that a current photographing mode is a self-photographing mode. Referring to FIG. 8D, the input image is automatically continuously captured. If a detected face is recognized as one of registered faces, continuous photographing may be automatically performed without determining whether a current photographing mode is a self-photographing mode.

Although a digital photographing apparatus to which the invention may be applied has been described above, the invention is not limited thereto. It is to be understood by one of ordinary skill in the art that a camera phone having a camera function, a personal digital assistant (PDA), or a portable multimedia player (PMP) may also be used.

The digital photographing apparatus described herein may include a processor, a memory for storing and executing program data, a permanent storage unit such as a disk drive, a communication port for handling communications with external devices, and a user interface device such as a touch panel, keys, and buttons. The methods may be implemented as software modules or algorithms, and may be stored as program instructions or computer-readable codes executable on the processor on a computer-readable recording medium. Here, examples of the computer-readable recording medium include a magnetic storage medium (e.g., a read-only memory (ROM), a random-access memory (RAM), a floppy disk, or a hard disk), and optical reading medium (e.g., a compact disk (CD)-ROM or a digital versatile disk (DVD)). The computer-readable recording medium may be distributed over network coupled computer systems so that the computer-readable code may be stored and executed in a distributed fashion. The computer-readable recording medium may be read by the computer, stored in the memory, and executed by the processor.

All references including publications, patent applications, and patents cited herein are hereby incorporated by reference to the same extent as if each reference were individually and specifically indicated to be incorporated by reference and were set forth in its entirety herein. For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The invention may be described in terms of functional blocks and various processing steps. Such functional blocks may be realized by any number of hardware or/and software components configured to perform specific functions. For example, the invention may employ various integrated circuit components, e.g., memory elements, processing elements, logic elements, and look-up tables, and the like, which may carry out a variety of functions under the control of one or more microprocessors or other control devices. Similarly, where the elements of the invention are implemented using software programming or software elements, the invention may be implemented with any programming or scripting language, such as C, C++, Java, or assembler, with various algorithms being implemented with any combination of data structures, objects, processes, routines, or other programming elements. Functional embodiments may be implemented in algorithms that execute on one or more processors. Furthermore, the invention could employ any number of conventional techniques for electronics configuration, signal processing and/or control, data processing, and the like. The terms “mechanism”, “element”, “means”, and “configuration” are broadly used, and are not limited to mechanical and physical embodiments, but can include software routines in connection with processors, etc.

The particular implementations shown and described herein are illustrative examples of the invention and are not intended to otherwise limit the scope of the invention in any way. For the sake of brevity, conventional electronics, control systems, software development and other functional embodiments of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections, may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those skilled in this art without departing from the spirit and scope of the invention.

As described above, the digital photographing apparatus according to the invention may control a front display unit to be turned on or off according to a result of face detection in such a manner that the front display unit is automatically turned on if a user is viewing the digital photographing apparatus and it is determined that a current photographing mode is a self-photographing mode by using registered face recognition information, and may automatically perform continuous photographing if a registered face is well composed according to settings.

Furthermore, the digital photographing apparatus according to the invention may obtain a nice image since the digital photographing apparatus allows the user to respond when or after he/she is photographed, and may reduce power consumption since the front display unit is not always turned on.

While the invention has been particularly shown and described with reference to exemplary embodiments thereof, it will be understood by one of ordinary skill in the art that various changes in form and details may be made therein without departing from the spirit and scope of the invention as defined by the following claims.

What is claimed is:

1. A digital photographing apparatus comprising:
a first display unit disposed on a rear surface of the digital photographing apparatus;
a second display unit disposed on a front surface of the digital photographing apparatus; and
a digital signal processing unit for turning on the second display unit if a face is detected in an input image.

2. The digital photographing apparatus of claim 1, wherein the digital signal processing unit comprises:
a face detecting unit for detecting a face in the input image; and
a control unit for turning on the second display unit if a face is detected in the input image.

3. The digital photographing apparatus of claim 2, wherein, if a face is detected in the input image, the control unit turns on the second display unit after a predetermined period of time elapses.

4. The digital photographing apparatus of claim 2, wherein, if no face is detected in the input image, the control unit turns off the second display unit after a predetermined period of time elapses.

5. The digital photographing apparatus of claim 4, wherein the control unit controls the face detecting unit to perform face detection on the input image after the predetermined period of time elapses.

6. A digital photographing apparatus comprising:
a first display unit disposed on a rear surface of the digital photographing apparatus;
a second display unit disposed on a front surface of the digital photographing apparatus; and
a digital signal processing unit for, if a face is detected in an input image, performing face recognition by comparing the detected face with a registered face, and continuously photographing the input image according to a result of the face recognition.

7. The digital photographing apparatus of claim 6, wherein the digital signal processing unit comprises:
a face detecting unit for detecting a face in the input image;
a face recognizing unit for performing face recognition by comparing the detected face with the registered face;
a continuous photographing control unit for controlling the input image to be continuously captured; and
a control unit for, if the detected face is the registered face, controlling the continuous photographing control unit to continuously capture the input image.

8. The digital photographing apparatus of claim 7, wherein the digital signal processing unit further comprises a photographing mode determining unit for determining whether a current photographing mode of the digital photographing apparatus is a self-photographing mode,
wherein, if the detected face is the registered face and the current photographing mode is a self-photographing mode, the control unit controls the continuous photographing control unit to continuously capture the input image.

9. A method of controlling a digital photographing apparatus comprising a first display unit and a second display unit, the method comprising:
detecting a face in an input image; and
turning on the second display unit if a face is detected in the input image.

10. The method of claim 9, wherein the turning-on of the second display unit comprises turning on the second display unit after a predetermined period of time elapses.

11. The method of claim 9, wherein, if no face is detected in the input image, the method further comprises turning off the second display unit after a predetermined period of time elapses.

12. The method of claim 11, further comprising performing face detection in the input image after the predetermined period of time elapses.

13. A method of controlling a digital photographing apparatus comprising a first display unit and a second display unit, the method comprising:
detecting a face in an input image;
performing face recognition by comparing the detected face with a registered face; and
continuously capturing the input image according to a result of the face recognition.

14. The method of claim 13, wherein the continuously capturing of the input image comprises continuously capturing the input image if the detected face is the registered face.

15. The method of claim 13, further comprising determining whether a current photographing mode of the digital photographing apparatus is a self-photographing mode,
wherein the continuously capturing of the input image comprises continuously capturing the input image if the detected face is the registered face and the current photographing mode is a self-photographing mode.

16. The method of claim 13, wherein the first display unit is disposed on a rear surface of the photographing apparatus, and the second display unit is disposed on a front surface of the digital photographing apparatus.
